(19) United States
(12) Patent Application Publication
(10) Pub. No.: US 2010/0312732 A1
(43) Pub. Date: Dec. 9, 2010

(54) METHODS AND SYSTEMS FOR RESPONSE DETECTION AND EFFICACY

(75) Inventors: Anthony G. Quinn, Chestnut Hill, MA (US); Palanikumar Ravindran, Edison, NJ (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Roche Palo Alto, Palo Alto, CA (US)

(21) Appl. No.: 12/793,185

(22) Filed: Jun. 3, 2010

Related U.S. Application Data
(60) Provisional application No. 61/184,689, filed on Jun. 5, 2009.

(51) Int. Cl. G06F 19/00

(52) U.S. Cl. 706/20

(57) ABSTRACT

Techniques are provided for analyzing clinical trial data and other medical information in order to understand heterogeneity of response within a population to a treatment under study. These techniques can support the development of personalized medical treatments and provide a better understanding of variability within the population to the effects of existing and new therapies. Additionally, these techniques can robustly define how subjects in the population respond to a treatment under study to differentiate between different responses, such as non-response and response followed by relapse. Therefore, the likely biology that is different in these responses can be identified to predict future response using any number of identified markers.

### CROSS-REFERENCES TO RELATED APPLICATIONS

This Application claims the benefit of and priority to U.S. Provisional Application No. 61/184,689, filed Jun. 5, 2009 and entitled “Methods And Systems For Response Detection And Efficacy,” which is hereby incorporated by reference for all purposes.

### BACKGROUND OF THE INVENTION

This disclosure relates to information processing systems. More specifically, this disclosure relates to systems and methods for detecting response in subjects to a treatment and efficacy thereof.

Typically, when a patient is seen in a clinical trial visit or by a physician for a condition of disease, a clinical examination is performed. During the clinical examination, measurements may be taken for any number of disease variables or other quantifiable parameters of disease activity. For example, for a patient afflicted with rheumatoid arthritis (RA), four types of measures are often used, including swollen/soft joint counts, radiographs, laboratory tests, and patient questionnaires.

It is well recognized in practice that there can be marked differences between patients in the effectiveness of different therapies. For example, during clinical trials, measures of disease variables or other quantifiable parameters of disease activity taken at a single point in time may have variability, such as whether the patient is having a good day or not. As with RA, joint counts can be one of the most specific measures, but are usually poorly reproducible.

Therefore, the inventors have recognized a need to develop new approaches for detecting how patients respond to a treatment and the efficacy thereof. Accordingly, what is desired is to solve problems relating to variability in disease variables or other quantifiable parameters of disease activity at a single time point, some of which may be discussed herein. Additionally, what is desired is to reduce drawbacks related to predicting efficacy of a treatment for a subject notwithstanding variability in disease variables or other quantifiable parameters of disease activity, some of which may be discussed herein.

### BRIEF SUMMARY OF THE INVENTION

In various embodiments, techniques are provided for analyzing clinical trial data and other medical information in order to understand heterogeneity of response within a population to a treatment under study. These techniques can support the development of personalized medical treatments and provide a better understanding of variability within the population to the effects of existing and new therapies. Additionally, these techniques can robustly define how subjects in the population respond to a treatment under study to differentiate between different responses, such as non-response and response followed by relapse. Therefore, the likely biology that is different in these responses can be identified to predict future response using any number of identified markers.

In one embodiment, a method for detecting how subjects in a population respond to a treatment can include receiving data associated with a population having a medical condition. The medical condition may include conditions observable through diagnostic markers of disease activity, such as rheumatoid arthritis or the like. The data may include measurements relevant to disease activity associated with the medical condition for each subject in the population obtained before a treatment. The data may further include measurements relevant to disease activity associated with the medical condition for each subject in the population obtained after or during the treatment. In addition to the data, a response specification can be received. The response specification may define a set of response profiles and information specifying how one or more relationships between measurements relevant to disease activity associated with the medical condition for a subject obtained before a treatment and measurements relevant to disease activity associated with the medical condition for the subject obtained after or during the treatment are used by an information processing device to classify the subject into at least one response profile in the set of response profiles. The data associated with the population can be analyzed using the response specification to determine how the measurements relevant to disease activity associated with the medical condition for each subject in the population obtained before the treatment change in relation to the measurements relevant to disease activity associated with the medical condition for the subject obtained after or during the treatment. Each subject in the population can be classified into the set of response profiles defined by the response specification based on the change in relation to the measurements relevant to disease activity associated with the medical condition for the subject obtained after or during the treatment.

In some embodiments, the set of response profiles defined by the response specification can include one or more of a flat/above response profile, a fast non-sustained full response profile, a fast non-sustained partial response profile, a fast sustained full response profile, a fast sustained partial response profile, a slow non-sustained full response profile, a slow non-sustained partial response profile, a slow sustained full response profile, or a slow non-sustained partial response profile.

In further embodiments, information may be generated specifying a response phenotype for a response profile. In one embodiment, a first diagnostic marker associated with the medical condition may be identified in a first response profile. A second diagnostic marker associated with the medical condition may be identified in a second response profile. Differences may be determined between the first diagnostic marker in the first response profile and the second diagnostic marker in the second response profile. In still further embodiments, a pattern of response may be determined from the set of response profiles that is characteristic of a drug associated with the treatment of the medical condition. A difference may then be determined between the pattern of response that is character of the drug and another pattern of response that is characteristic of another drug. In one embodiment, a response profile in the set of response profiles may be associated with a clinical outcome.

A further understanding of the nature, advantages, and improvements offered by those innovations disclosed herein may be realized by reference to remaining portions of this disclosure and any accompanying drawings.

### BRIEF DESCRIPTION OF THE DRAWINGS

In order to better describe and illustrate embodiments and/or examples of any innovations presented within this disclosure, reference may be made to one or more accompanying drawings. The additional details or examples used to describe the one or more accompanying drawings should not be considered as limitations to the scope of any of the disclosed inventions, any of the presently described embodiments and/or examples, or the presently understood best mode of any innovations presented within this disclosure.

FIG. 1 is an illustration of a typical trial process in one embodiment according to the present invention.

FIG. 2 is simplified flowchart of a method for analyzing trial data in one embodiment according to the present invention.

FIG. 3 is a simplified flowchart of a method for generating a response specification in one embodiment according to the present invention.

FIGS. 4A and 4B are illustrations of clustering used to define a set of response profiles and a set of relationships in one embodiment according to the present invention.

FIG. 5 is a flowchart of a method for classifying subjects in a population into a set of response profiles based on a response specification in one embodiment according to the present invention.

FIGS. 6A, 6B, 6C, 6D, 6E, 6F, 6G, 6H, and 61 are illustrations of a set of response profiles in one embodiment according to the present invention.

FIG. 7 is a flowchart of a method for generating a temporal profile for a subject in one embodiment according to the present invention.

FIG. 8 is a simplified flowchart of a method for comparing a temporal profile of a subject to a set of response profiles in one embodiment according to the present invention.

FIG. 9 is a flowchart of a method for determining differences between response phenotypes in one embodiment according to the present invention.

FIG. 10 is a flowchart of a method for individualizing treatment based on a subject's temporal profile in one embodiment according to the present invention.

FIG. 11 is a simplified block diagram of a computer system 1100 that may incorporate embodiments of the present invention.

### DETAILED DESCRIPTION OF THE INVENTION

In various embodiments, techniques are provided for analyzing clinical trial data and other medical information in order to understand heterogeneity of response within a population to a treatment under study. These techniques can support the development of personalized medical treatments and provide a better understanding of variability within the population to the effects of existing and new therapies. Additionally, these techniques can robustly define how subjects in the population respond to a treatment under study to differentiate between non-response and response followed by relapse. Therefore, the likely biology that is different in these responses can be identified to predict future response using the identified markers.

Currently, much of medical practice is based on one more “standards of care.” These standards usually are determined by averaging responses across a large population. One prevalent theory has been that everyone should get the same care based on clinical trials of new therapies.

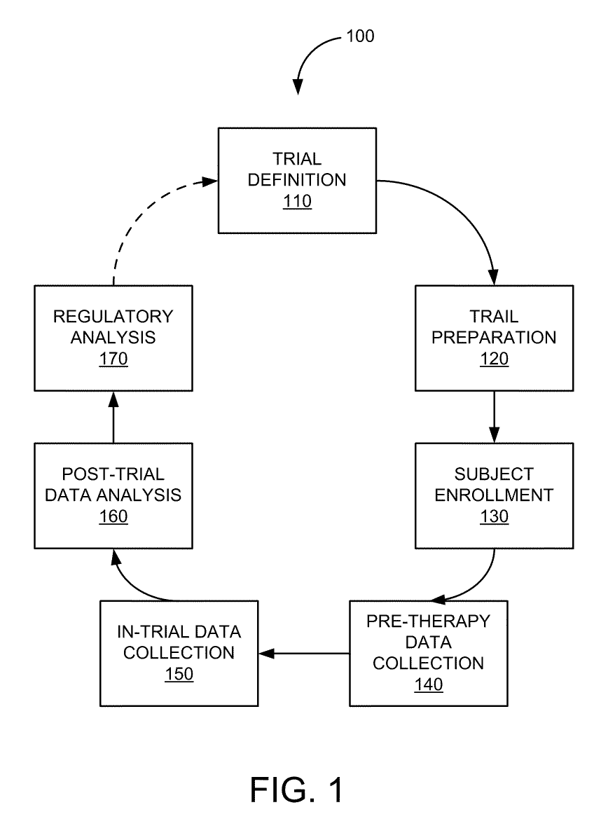

FIG. 1 is an illustration of trial process 100 in one embodiment according to the present invention. Although there are many definitions of clinical trials, they are generally considered to be biomedical or health-related research studies in subjects, such as human beings, that follow a pre-defined protocol developed in trial definition stage 110. An interventional and/or observational type studies may be defined during trial definition state 110 which the necessary preparations being made in trial preparation stage 120. In general, interventional studies can include those in which research subjects found in subject enrollment stage 130 are assigned by an investigator to a treatment or other intervention. Pre-trial data may be collected (e.g., in pre-therapy data collection stage 140) and in-trial data representing the outcomes of the treatment can be measured (e.g., in in-trail data collection stage). In another example, observational studies can include those in which subjects are observed and their outcomes are measured by the investigators. Most human use of investigational new drugs takes place in controlled clinical trials conducted to assess safety and efficacy of new drugs.

Data from the trials can serve as the basis for the drug marketing application (e.g., post-trial analysis stage 160 and regulatory analysis stage 170). As alluded to above, data analysis approaches to support drug registration tend to focus on population effects. However, it is well recognized in clinical practice that there are marked differences between subjects in the effectiveness of different therapies.

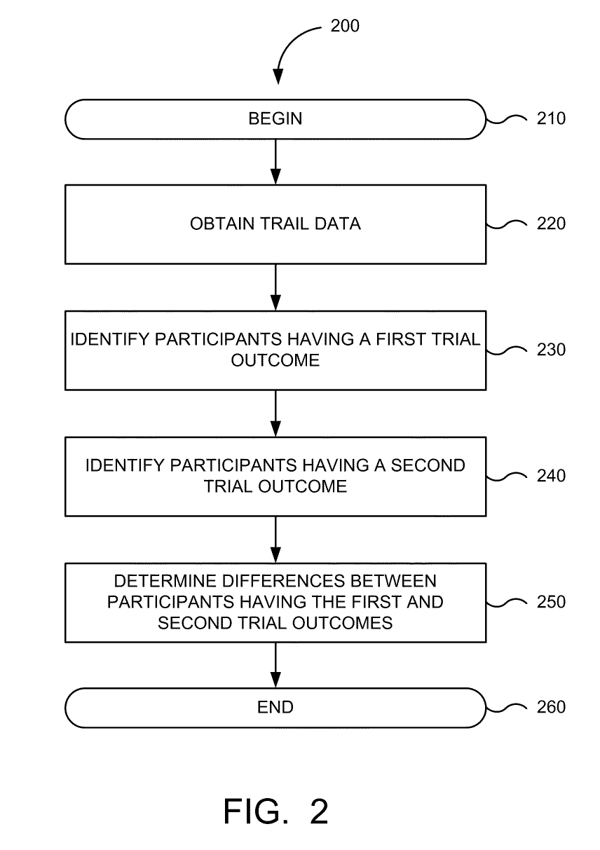

In various embodiments, to better understand variability within a population to the effects of existing and new therapies trial data can be analyzed to successfully identify biological markers (biomarkers) to predict response to therapies. FIG. 2 is simplified flowchart of a method for analyzing trial data in one embodiment according to the present invention. The processing of method 200 depicted in FIG. 2 may be performed by software (e.g., instructions or code modules) when executed by a central processing unit (CPU or processor) of a logic machine, such as a computer system or information processing device, by hardware components of an electronic device or application-specific integrated circuits, or by combinations of software and hardware elements. Method 200 depicted in FIG. 2 begins in step 210.

In step 220, trial data is obtained. In various embodiments, the trial data may be obtained from conducting clinical trials. In other embodiments, trial data may be obtained from maintained repositories and other sources, such as records of past trials, tests, or the like. The trial data may include information about subjects in a population, such as a subject's physical characteristics, patient history, family history, lab or other diagnostic results, genetic profile, genetic test results, or the like. The trial data may include observations of disease activity or measurements of various disease variables obtain before, during, and after application of a given therapy.

In step 230, participants having a first trial outcome are identified. In step 240, participants having a second trial outcome are identified. Some examples of a trial outcome can include a cure or sustained response to a drug or therapy under study, a placebo response, a non-response, a partial response, or the like. Another example of a trial outcome may include adverse responses or unexpected responses, both helpful and unhelpful.

In step 250, differences between the participants having the first and second trial outcomes are determined. The differences between the participants may be used to evaluate effectiveness of the treatment. For example, in clinical trials for rheumatoid arthritis, standard criteria to compare the effectiveness of various arthritis medications or arthritis treatments, or to compare one trial to another trial has become widely used. This criteria is commonly known as ACR Criteria or American College of Rheumatology Criteria and is referred to in nearly all published studies assessing efficacy. ACR criteria is indicated as ACR 20, ACR 50, and ACR 70. In general, ACR criteria measures improvement in tender or swollen joint counts and improvement in three of the following five parameters: acute phase reactant (such as sedimentation rate), patient assessment, physician assessment, pain scale, and disability/functional questionnaire.

In further embodiments, the differences between the participants may be used to identify biomarkers that predict a patient's response to the treatment. Accordingly, the variability of patient response in large data sets, such as those obtained from clinical trials, can be more effectively analyzed to guide future development. FIG. 2 ends in step 260.

### Defining Response

In various embodiments, population data can be effectively analyzed to differentiate between different patterns of response to a therapy allows identification of true non-responders, patients who respond and relapse, and patients who respond and show a sustained improvement. From these response profiles, a response phenotype may be developed that includes the observable physical or biochemical characteristics of the subject, as determined by both genetic makeup and environmental. The response biomarkers can be used to support industries, such as the pharmaceutical industry, that may have large datasets from which they can further develop. In addition, the response biomarkers may assist a physician in a clinic to support a decision in treatment.

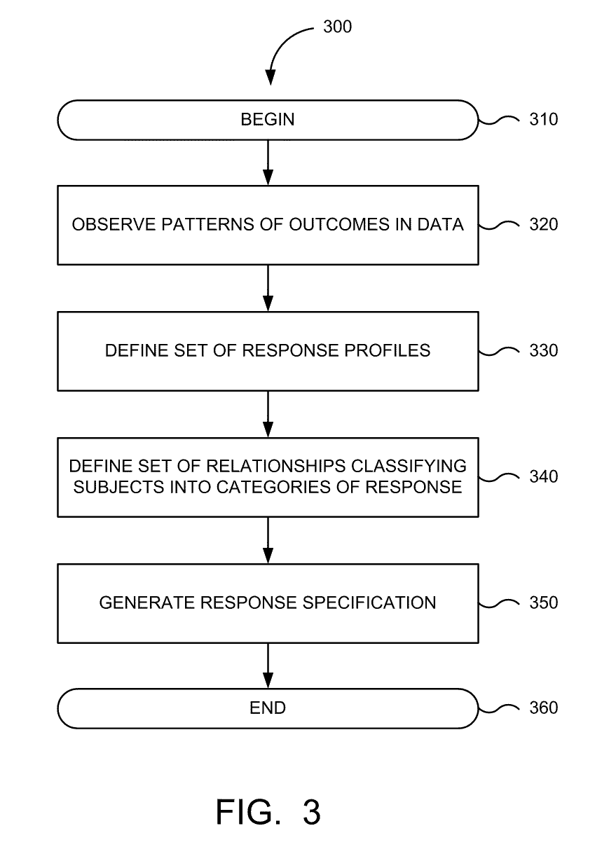

In various embodiments, a definition of response can be provided by a response specification. The response specification can include any information that defines one or more response profiles and one or more relationships between a subject's information or other criteria that categorize the subject into the response profiles. FIG. 3 is a simplified flowchart of method 300 for generating a response specification in one embodiment according to the present invention. Method 300 depicted in FIG. 3 begins in step 310.

In step 320, one or more patterns of outcomes are observed in data associated with a population. The patterns of outcomes may include whether a subject fully responded to a treatment, partially responded to a treatment, did not respond at all to a treatment, had adverse effects to a treatment, or the like. Patterns of outcomes may be observed manually or automatically using software programs.

In step 330, a set of one or more response profiles are defined. In general, a response profile represents the extent to which a subject exhibits various characteristics of a pattern of outcome. A response profile can correspond to a clinical outcome, such as non-response or full response, or to any category or division of how a subject responded to a treatment under study. In some embodiments, the set of response profiles may be arbitrarily determined by a user without clinical significance.

In step 340, a set of relationships classifying subjects into categories of response are defined. The relationships or other criteria that categorize the subject into the response profiles can include rules, conditions, thresholds, limits, or the like. These may involve multiple time points in the subject's information, such as time points occurring before a particular treatment or therapy and time points occurring during or after the treatment or therapy. In one embodiment, the set of relationships can be provided by a user to allow the user to robustly define response to a given treatment or therapy. In other embodiments, the set of relationships can be defined explicitly, procedurally, using data analysis or sampling or fitting techniques, or the like.

In step 350, a response specification is generated. The response specification can include the set of response profiles and the set of relationships classifying subjects into categories of response. The response specification may be generated to be readable by a computer system or information processing device for analysis of population data to differentiate between different patterns of response to a therapy allows identification of true non-responders, patients who respond and relapse, and patients who respond and show a sustained improvement. As discussed above, from these response profiles, a response phenotype may be developed that includes the observable physical or biochemical characteristics of the subject, as determined by both genetic makeup and environmental. The response biomarkers can be used to support industries, such as the pharmaceutical industry, that may have large datasets from which they can further develop. In addition, the response biomarkers may assist a physician in a clinic to support a decision in treatment. FIG. 3 ends in step 360.

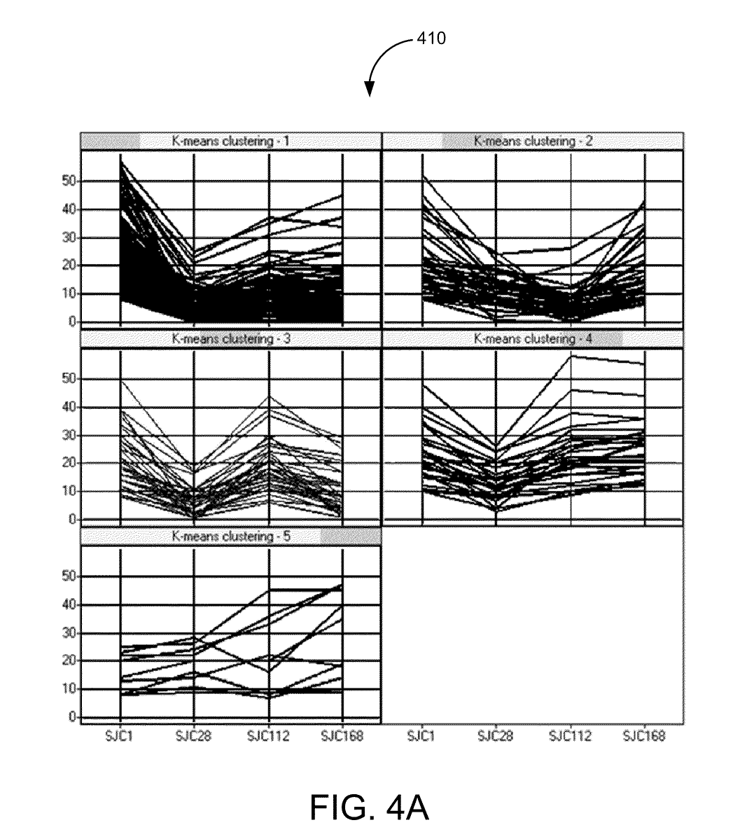

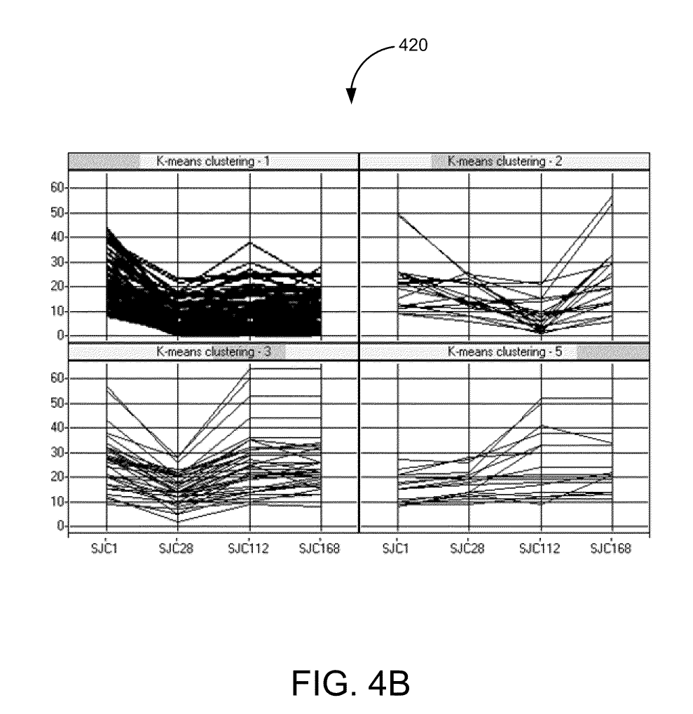

FIGS. 4A and 4B are illustrations of clustering used to define a set of response profiles and a set of relationships in one embodiment according to the present invention. In this example, measurements relevant to disease activity associated with the treatment of subjects known to have rheumatoid arthritis (RA) with Rituximab (MABTHERA offered by Roche) are collected at a plurality of time points. Rituximab is a chimeric monoclonal antibody against the protein CD20, which is primarily found on the surface of B cells. Rituximab can be used in the treatment of many lymphomas, leukemias, and some autoimmune disorders, such as RA. These measurements can include an initial baseline of values collected before an intervention. These measurements may be observed or otherwise analyzed to identify patterns of response.

In this example, K-means clustering is used to simplify the larger dataset of clinical trial data into groups or partitions of response. Groups 410 shown in FIG. 4A represent patterns of response for subjects in a population taking a drug under study. Groups 420 shown in FIG. 4B represent patterns of response for subjects taking a placebo. Other types of clustering or data fitting may be used to extract relationships from population data.

### Dataset Analysis

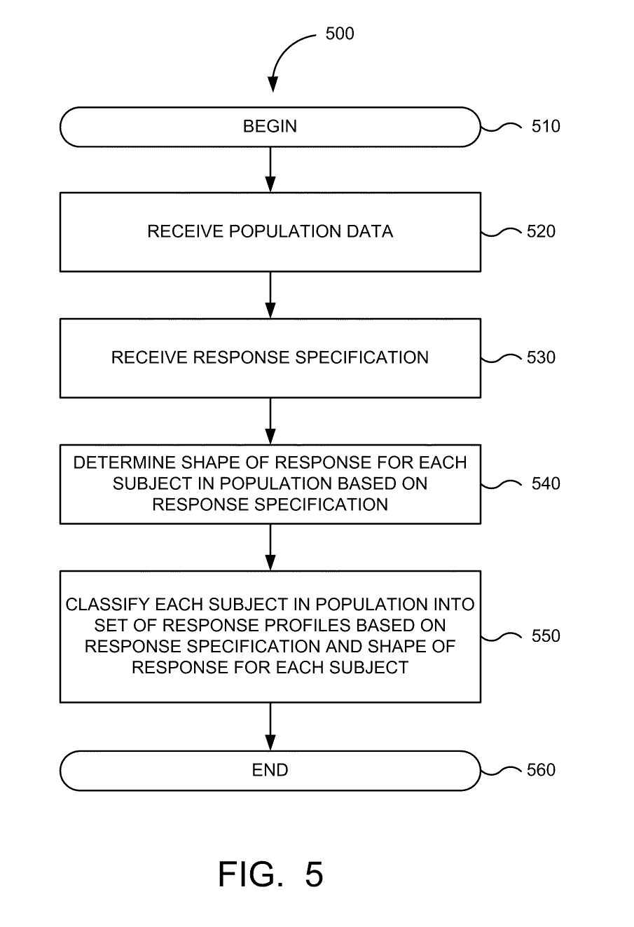

In various embodiments, once response has been defined and a response specification created, the frequency of different profiles can be investigated in placebo and treatment groups of a dataset to provide information about the characteristic temporal response profile for a therapy under study. FIG. 5 is a flowchart of method 500 for classifying subjects in a population into a set of response profiles based on a response specification in one embodiment according to the present invention. Method 500 depicted in FIG. 5 begins in step 510.

In step 520, population data is received. The population data can include data associated with a population having a medical condition. Some examples of medical conditions can include cancers, autoimmune diseases, cardiovascular diseases, or the like. The population data may include measurements relevant to disease activity for each subject in the population obtained before a treatment. The population data may include measurements relevant to disease activity for each subject in the population obtained after or during the treatment.

In step 530, a response specification is received. As discussed above, the response specification can include a set of response profiles and information specifying how one or more relationships between measurements relevant to disease activity for a subject obtained before a treatment and measurements relevant to disease activity for the subject obtained after or during the treatment are used to classify the subject into at least one response profile in the set of response profiles.

One example of a response specification may provide:

Let MIN be the minimum value of % change from baseline value for
a patient. Then if MIN is:

is less than −80 then it is classified as “full”
is between −80 and −40 then it is classified as “partial”
otherwise,

if it is great than −40 then it is classified as “flat/above”

Only for the “full” and “partial” patients the following steps are
performed:

If the first time point after baseline is less than 20 + MIN

then it is classified as “fast”,
otherwise it is classified as “slow”

If there is a continuous increase of more then 80%

then it is classified as “not sustained”
otherwise if the final time point is below −80 or −40 (for

“full or “partial” respectively) or {if the penultimate time point is
below −80 or −40 (for “full or “partial” respectively) and the final time
point is less than 20 + penultimate time point} then it is classified as
“sustained”

otherwise it is classified as “not sustained.”

In step 540, shape of a response for each subject in the population is determined based on the response specification. In various embodiments, the shape of the response for each subject is determined based on multiple time points in the population data. This temporal profile for each subject can be used to classify the subject into category of response.

In step 550, each subject in the population is classified into the set of response profiles based on the response specification and shape of each response for you subject. In the above example, the % change calculated for each patient from baseline values for the given variable over various time points can be used to categorized or classify patients into the set of response profiles. FIG. 5 ends in step 560.

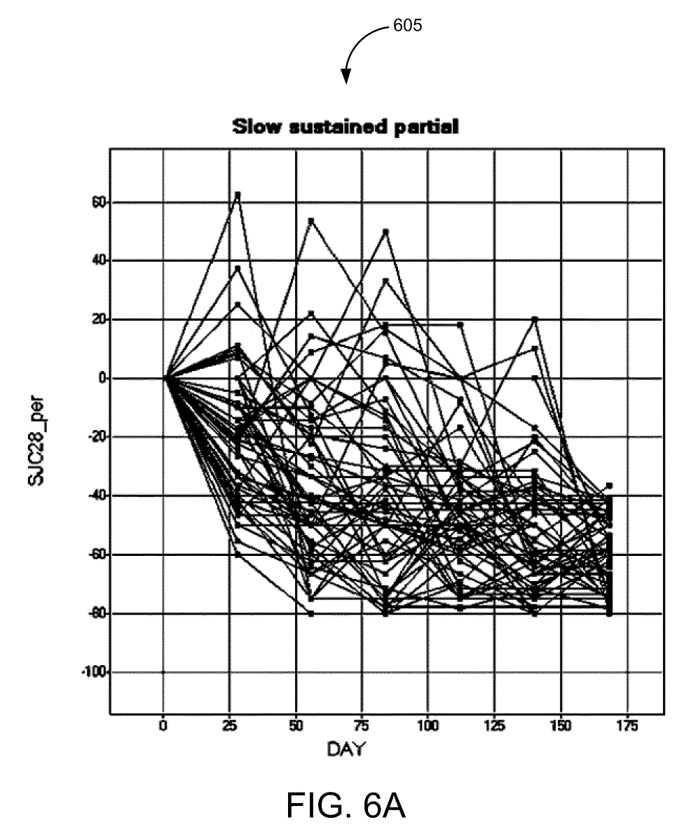

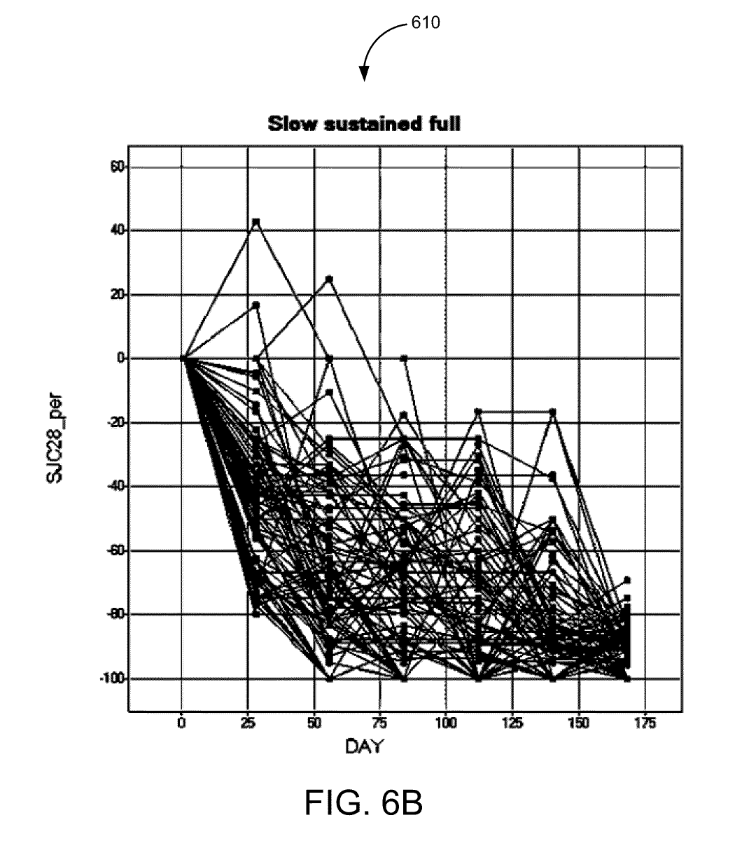

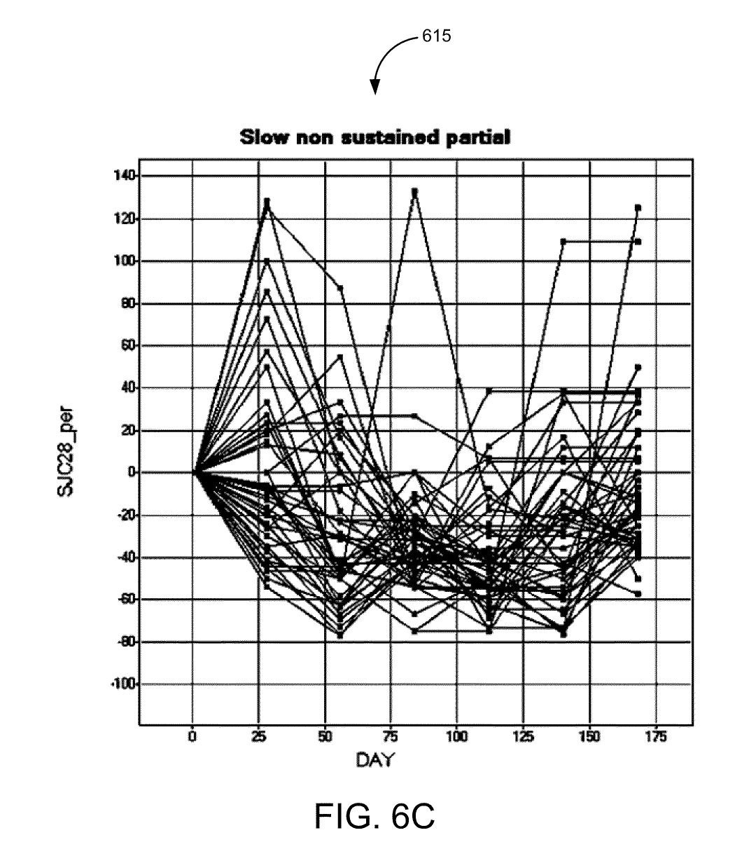

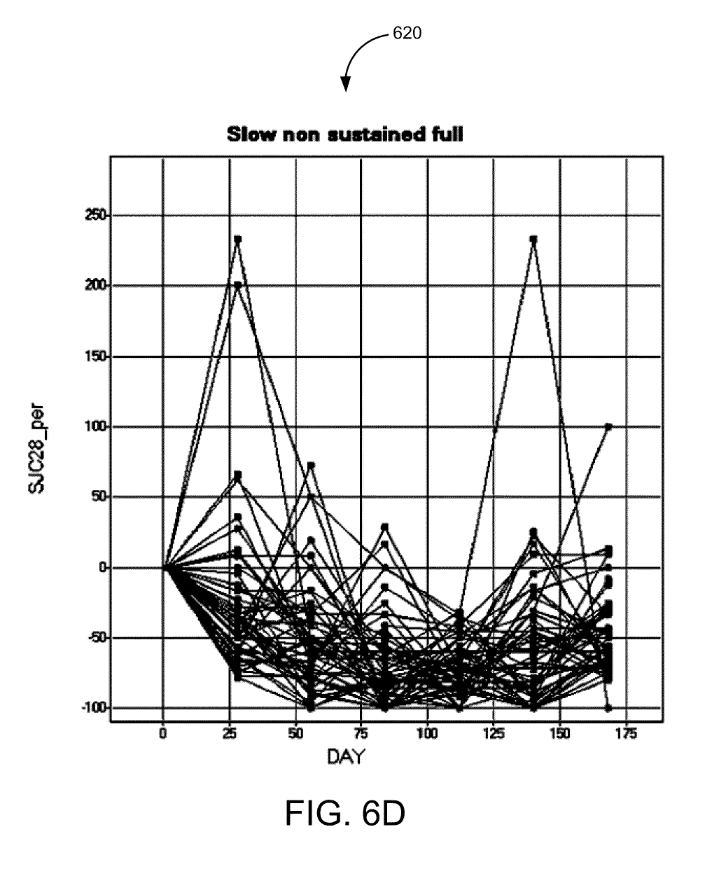

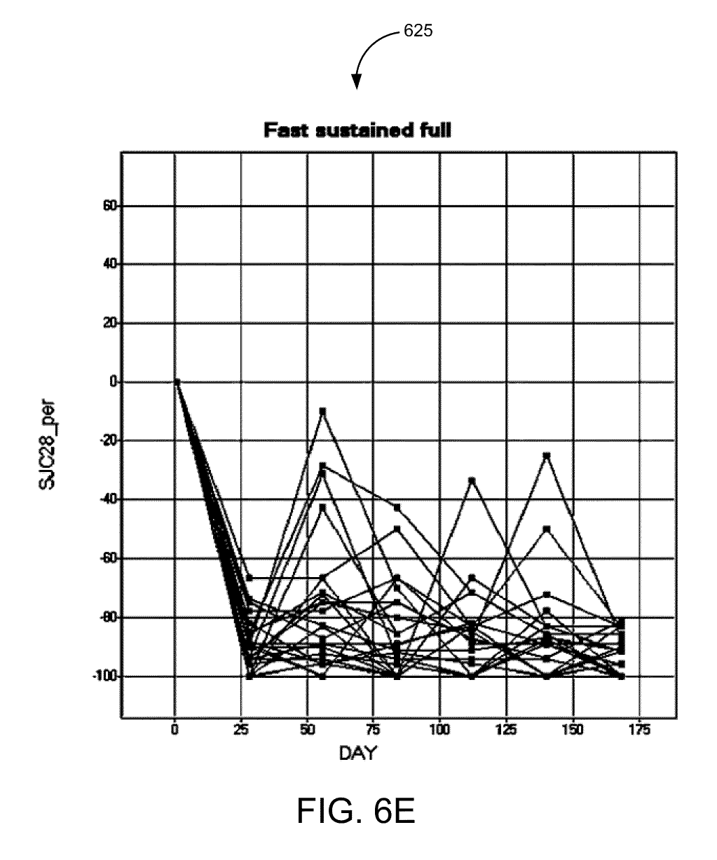

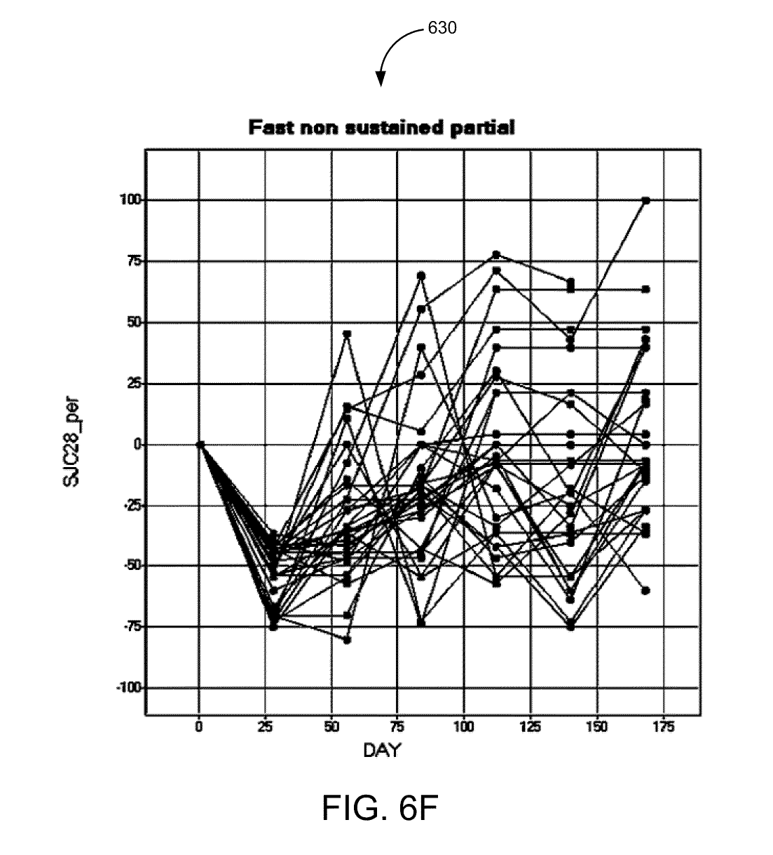

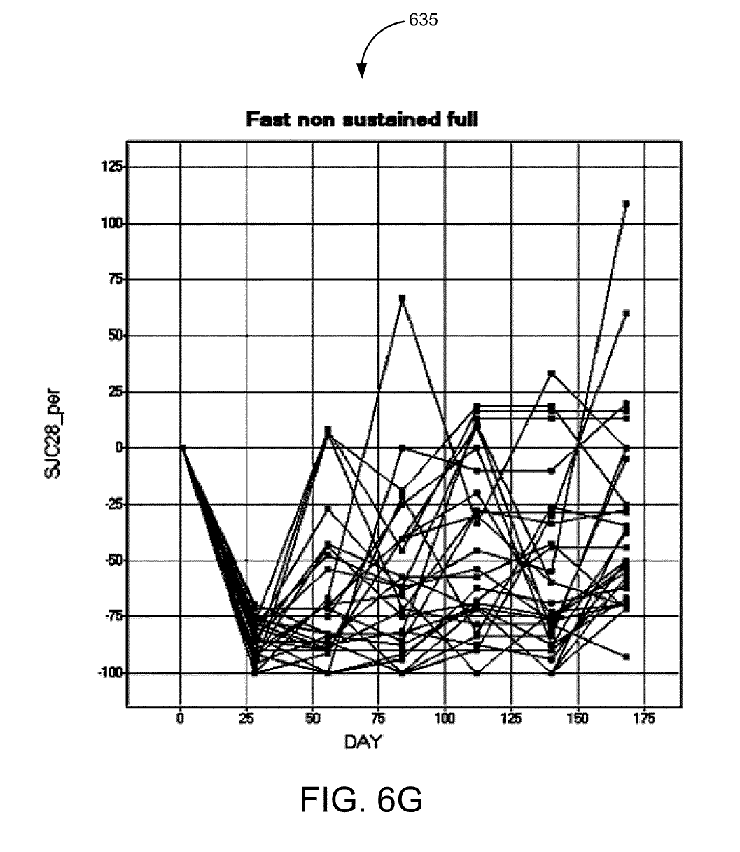

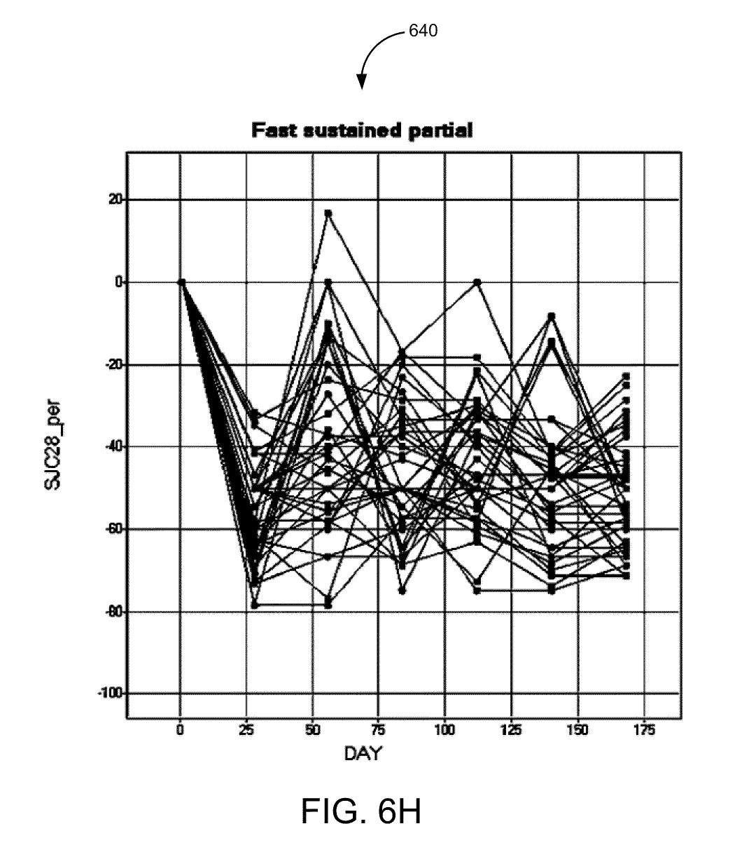

FIGS. 6A, 6B, 6C, 6D, 6E, 6F, 6G, 6H, and 6I are illustrations of a set of response profiles in one embodiment according to the present invention. In this example, the set of response profiles includes slow sustained partial response profile 605 shown in FIG. 6A, slow sustained for response profile 610 shown in FIG. 6B, slow non-sustained partial response profile 615 shown in FIG. 6C, and slow non-sustained full response profile 620 shown in FIG. 6D. The set of response profiles also includes fast sustained full response profile 625 shown in FIG. 6E, fast non-sustained partial response profile 630 shown in FIG. 6F, fast non-sustained full response profile 635 shown in FIG. 6G, fast sustained partial response profile 640 shown in FIG. 6H. Additionally, the set of response profiles includes flat above response profile 645 shown in FIG. 6I.

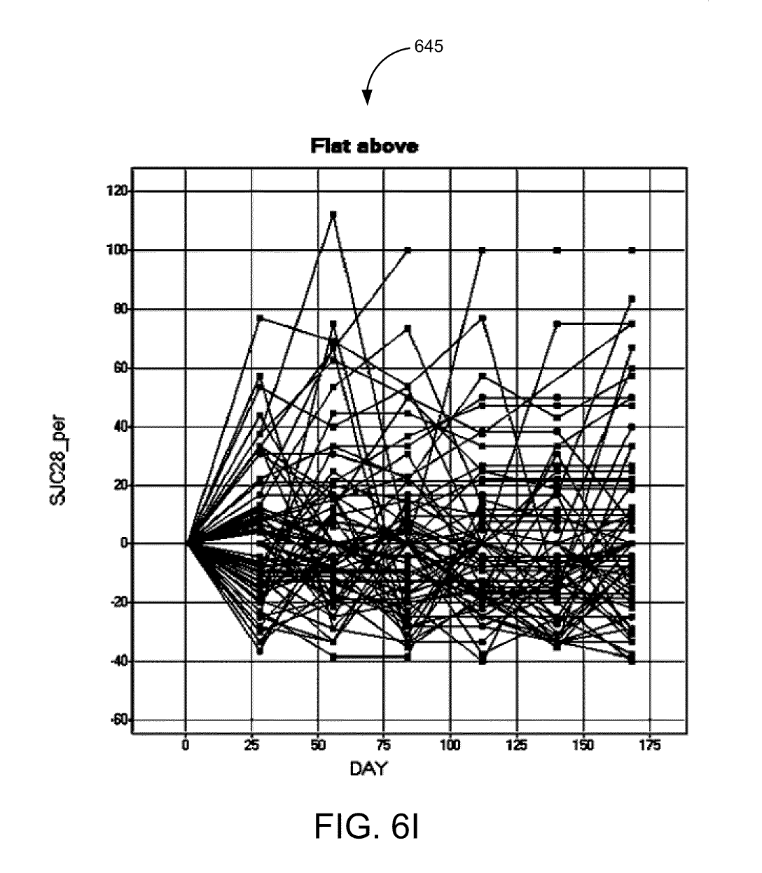

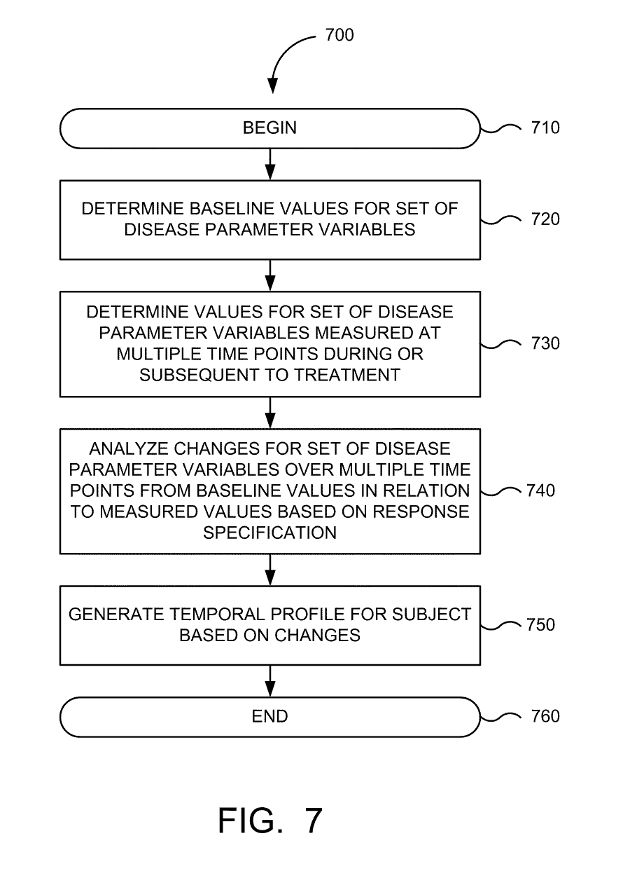

FIG. 7 is a flowchart of method 700 for generating a temporal profile for a subject in one embodiment according to the present invention. Method 700 depicted in FIG. 7 begins in step 710. In step 720, one or more baseline values for a set of disease parameter variables are determined. These baseline values may be obtained before an intervention. In step 730, values for the set of disease parameter variables measured during or subsequent to a treatment are determined. In step 740, changes are analyzed for the set of disease parameter variables over multiple time points from the baseline values in relation to the measured values based on the response specification. In step 750, a temporal profile is generated for the subject based on the changes. FIG. 7 ends in step 760.

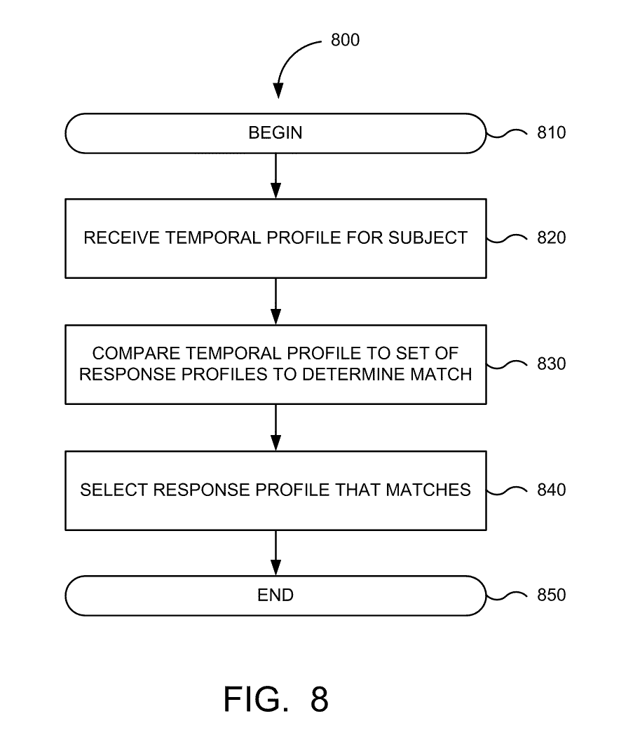

FIG. 8 is a simplified flowchart of method 800 for comparing a temporal profile of a subject to a set of response profiles in one embodiment according to the present invention. Method 800 depicted in FIG. 8 begins in step 810. In step 820, a temporal profile for a subject is received. In step 830, the temporal profile for the subject is compared to a set of response profiles to determine a match. The match may include a full match or a partial match. In one example, the individual data points of the subject's temporal profile may be compared to data points of each response profile in the set of response profiles. In step 840, a response profile is selected that matches the temporal profile for the subject. FIG. 8 ends in step 850.

### Diagnostic Markers Analysis

In various embodiments, once response has been defined and a response specification created, individuals within a pattern can be looked at to determine what makes those people different from other individuals in other response groups. This allows the identification of biomarkers predictive of responder/non-responders and/or relapsing patient populations.

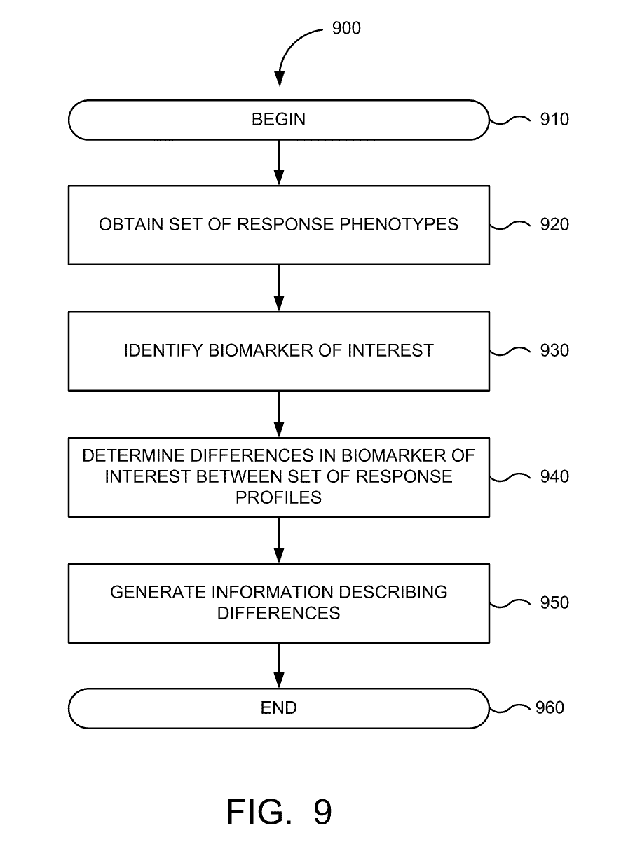

FIG. 9 is a flowchart of method 900 for determining differences between response phenotypes in one embodiment according to the present invention. Method 900 in FIG. 9 begins in step 910. In step 920, a set of response phenotypes is obtained. For example, once the set of response profiles is determined, the set of response profiles may be generated based on the population data for each subject within a response profile. A response phenotype can include the observable physical or biochemical characteristics of the subject, as determined by both genetic makeup and environmental.

In step 930, one or more biomarkers of interest may be determined. The biomarkers may be selected manually or programmatically. In step 940, differences in biomarkers of interest may be determined between the set of response profiles. Instead 950, information describing these differences may be generated.

Accordingly, biomarkers that are predictive of response or non-response or other types of outcomes may be identified in the population data. FIG. 9 ends in step 960.

### Personalized Treatment

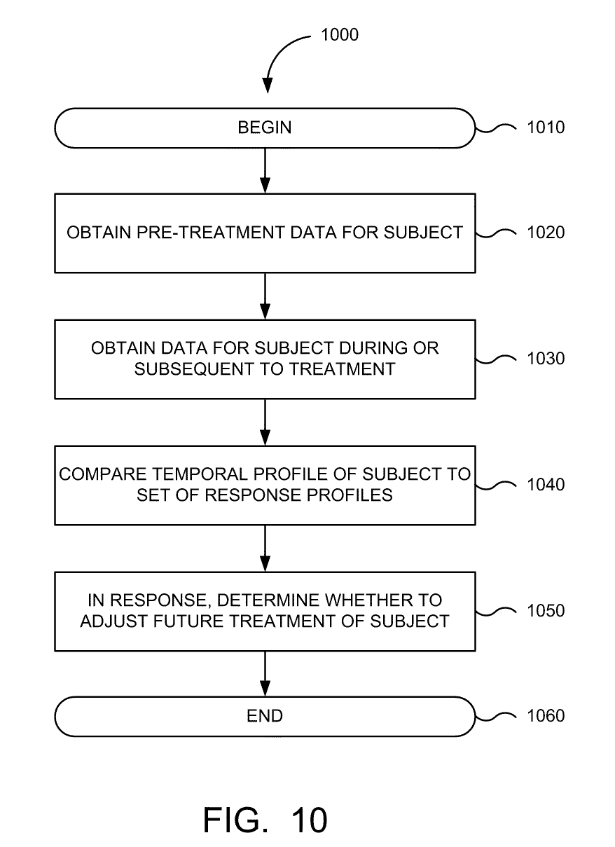

FIG. 10 is a flowchart of method 1000 for individualizing treatment based on a subject's temporal profile in one embodiment according to the present invention. Method 1000 shown in FIG. 10 begins in step 1010.

In step 1020, pretreatment data for a subject is obtained. In step 1030, data during or subsequent to treatment of the subject is obtained. In step 1040, a temporal profile of the subject is compared to a set of response profiles. The set of response profiles may be previously generated based on other studies of the treatment.

In step 1050, in response to the comparison, a determination is made whether to adjust future treatment of the subject. For example, the comparison may result in a determination that the subject is a slow responder or a non-responder. A physician or other medical professional may determine to adjust treatment of the subject based on the subject's temporal profile. Some examples of altering treatment may include altering drug dosage, altering a treatment schedule, combining drugs with a treatment, or the like. FIG. 10 ends in step 1060.

### Information Processing Device

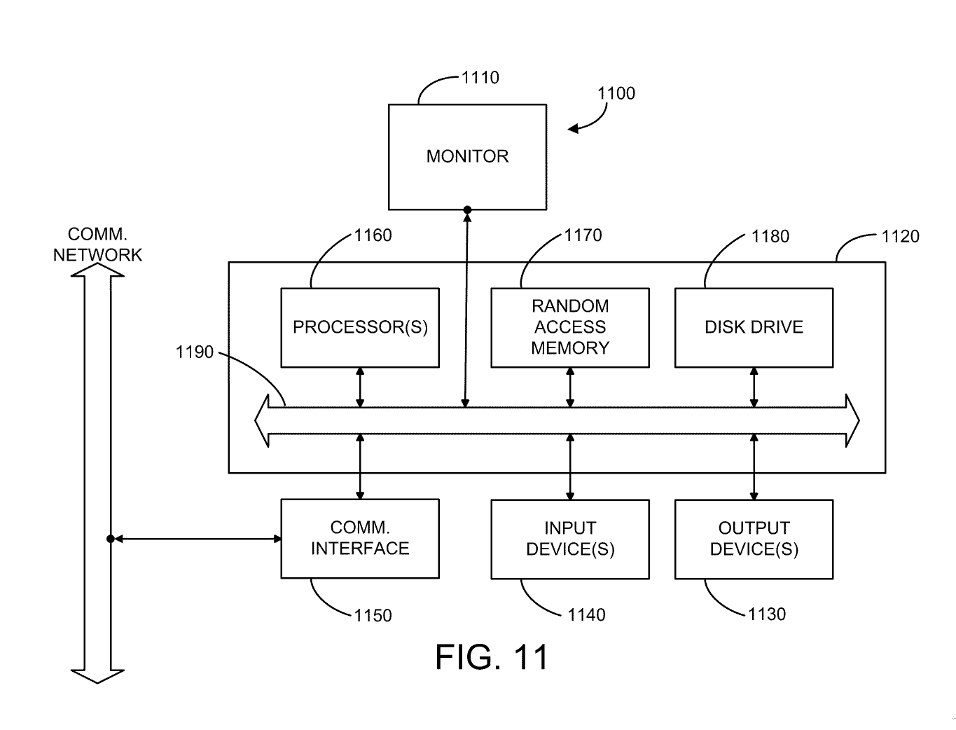

FIG. 11 is a simplified block diagram of a computer system 1100 that may incorporate embodiments of the present invention. FIG. 11 is merely illustrative of an embodiment incorporating the present invention and does not limit the scope of the invention as recited in the claims. One of ordinary skill in the art would recognize other variations, modifications, and alternatives.

In one embodiment, computer system 1100 typically includes a monitor 1110, a computer 1120, user output devices 1130, user input devices 1140, communications interface 1150, and the like.

As shown in FIG. 11, computer 1120 may include a processor(s) 1160 that communicates with a number of peripheral devices via a bus subsystem 1190. These peripheral devices may include user output devices 1130, user input devices 1140, communications interface 1150, and a storage subsystem, such as random access memory (RAM) 1170 and disk drive 1180.

User input devices 1130 include all possible types of devices and mechanisms for inputting information to computer system 1120. These may include a keyboard, a keypad, a touch screen incorporated into the display, audio input devices such as voice recognition systems, microphones, and other types of input devices. In various embodiments, user input devices 1130 are typically embodied as a computer mouse, a trackball, a track pad, a joystick, wireless remote, drawing tablet, voice command system, eye tracking system, and the like. User input devices 1130 typically allow a user to select objects, icons, text and the like that appear on the monitor 1110 via a command such as a click of a button or the like.

User output devices 1140 include all possible types of devices and mechanisms for outputting information from computer 1120. These may include a display (e.g., monitor 1110), non-visual displays such as audio output devices, etc.

Communications interface 1150 provides an interface to other communication networks and devices. Communications interface 1150 may serve as an interface for receiving data from and transmitting data to other systems. Embodiments of communications interface 1150 typically include an Ethernet card, a modem (telephone, satellite, cable, ISDN), (asynchronous) digital subscriber line (DSL) unit, FireWire interface, USB interface, and the like. For example, communications interface 1150 may be coupled to a computer network, to a FireWire bus, or the like. In other embodiments, communications interfaces 1150 may be physically integrated on the motherboard of computer 1120, and may be a software program, such as soft DSL, or the like.

In various embodiments, computer system 1100 may also include software that enables communications over a network such as the HTTP, TCP/IP, RTP/RTSP protocols, and the like. In alternative embodiments of the present invention, other communications software and transfer protocols may also be used, for example IPX, UDP or the like.

In some embodiment, computer 1120 includes one or more Xeon microprocessors from Intel as processor(s) 1160. Further, one embodiment, computer 1120 includes a UNIX-based operating system.

RAM 1170 and disk drive 1180 are examples of tangible media configured to store data such as embodiments of the present invention, including executable computer code, human readable code, or the like. Other types of tangible media include floppy disks, removable hard disks, optical storage media such as CD-ROMS, DVDs and bar codes, semiconductor memories such as flash memories, read-only-memories (ROMS), battery-backed volatile memories, networked storage devices, and the like. RAM 1170 and disk drive 1180 may be configured to store the basic programming and data constructs that provide the functionality of the present invention.

Software code modules and instructions that provide the functionality of the present invention may be stored in RAM 1170 and disk drive 1180. These software modules may be executed by processor(s) 1160. RAM 1170 and disk drive 1180 may also provide a repository for storing data used in accordance with the present invention.

RAM 1170 and disk drive 1180 may include a number of memories including a main random access memory (RAM) for storage of instructions and data during program execution and a read only memory (ROM) in which fixed instructions are stored. RAM 1170 and disk drive 1180 may include a file storage subsystem providing persistent (non-volatile) storage for program and data files. RAM 1170 and disk drive 1180 may also include removable storage systems, such as removable flash memory.

Bus subsystem 1190 provides a mechanism for letting the various components and subsystems of computer 1120 communicate with each other as intended. Although bus subsystem 1190 is shown schematically as a single bus, alternative embodiments of the bus subsystem may utilize multiple busses.

FIG. 11 is representative of a computer system capable of embodying the present invention. It will be readily apparent to one of ordinary skill in the art that many other hardware and software configurations are suitable for use with the present invention. For example, the computer may be a desktop, portable, rack-mounted or tablet configuration. Additionally, the computer may be a series of networked computers. Further, the use of other micro processors are contemplated, such as Pentium™ or Itanium™ microprocessors; Opteron™ or AthlonXP™ microprocessors from Advanced Micro Devices, Inc; and the like. Further, other types of operating systems are contemplated, such as Windows®, WindowsXP®, WindowsNT®, or the like from Microsoft Corporation, Solaris from Sun Microsystems, LINUX, UNIX, and the like. In still other embodiments, the techniques described above may be implemented upon a chip or an auxiliary processing board.

Various embodiments of the present invention can be implemented in the form of logic in software or hardware or a combination of both. The logic may be stored in a computer readable or machine-readable storage medium as a set of instructions adapted to direct a processor of a computer system to perform a set of steps disclosed in embodiments of the present invention. The logic may form part of a computer program product adapted to direct an information-processing device to perform a set of steps disclosed in embodiments of the present invention. Based on the disclosure and teachings provided herein, a person of ordinary skill in the art will appreciate other ways and/or methods to implement the present invention.

The specification and drawings are, accordingly, to be regarded in an illustrative rather than a restrictive sense. It will, however, be evident that various modifications and changes may be made thereunto without departing from the broader spirit and scope of the invention as set forth in the claims. The scope of the invention should, therefore, be determined not with reference to the above description, but instead should be determined with reference to the pending claims along with their full scope or equivalents.

Various embodiments of any of one or more inventions whose teachings may be presented within this disclosure can be implemented in the form of logic in software, firmware, hardware, or a combination thereof. The logic may be stored in or on a machine-accessible memory, a machine-readable article, a tangible computer-readable medium, a computer-readable storage medium, or other computer/machine-readable media as a set of instructions adapted to direct a central processing unit (CPU or processor) of a logic machine to perform a set of steps that may be disclosed in various embodiments of an invention presented within this disclosure. The logic may form part of a software program or computer program product as code modules become operational with a processor of a computer system or an information-processing device when executed to perform a method or process in various embodiments of an invention presented within this disclosure. Based on this disclosure and the teachings provided herein, a person of ordinary skill in the art will appreciate other ways, variations, modifications, alternatives, and/or methods for implementing in software, firmware, hardware, or combinations thereof any of the disclosed operations or functionalities of various embodiments of one or more of the presented inventions.

The disclosed examples, implementations, and various embodiments of any one of those inventions whose teachings may be presented within this disclosure are merely illustrative to convey with reasonable clarity to those skilled in the art the teachings of this disclosure. As these implementations and embodiments may be described with reference to exemplary illustrations or specific figures, various modifications or adaptations of the methods and/or specific structures described can become apparent to those skilled in the art. All such modifications, adaptations, or variations that rely upon this disclosure and these teachings found herein, and through which the teachings have advanced the art, are to be considered within the scope of the one or more inventions whose teachings may be presented within this disclosure. Hence, the present descriptions and drawings should not be considered in a limiting sense, as it is understood that an invention presented within a disclosure is in no way limited to those embodiments specifically illustrated.

Accordingly, the above description and any accompanying drawings, illustrations, and figures are intended to be illustrative but not restrictive. The scope of any invention presented within this disclosure should, therefore, be determined not with simple reference to the above description and those embodiments shown in the figures, but instead should be determined with reference to the pending claims along with their full scope or equivalents.

What is claimed is:

1. A method performed by an information processing device for detecting how subjects in a population respond to a treatment, the method comprising:
receiving, at the information processing device, data for a population having a medical condition, the data including:
measurements relevant to disease activity associated with the medical condition for each subject in the population obtained before a treatment, and
measurements relevant to disease activity associated with the medical condition for each subject in the population obtained after or during the treatment;
receiving, at the information processing device, a response specification defining:
a set of response profiles, and
information specifying how one or more relationships between measurements relevant to disease activity associated with the medical condition for a subject obtained before a treatment and measurements relevant to disease activity associated with the medical condition for the subject obtained after or during the treatment are used to classify the subject into at least one response profile in the set of response profiles;
analyzing the data for the population with the information processing device using the response specification to determine how the measurements relevant to disease activity associated with the medical condition for each subject in the population obtained before the treatment change in relation to the measurements relevant to disease activity associated with the medical condition for the subject obtained after or during the treatment; and
classifying each subject in the population with the information processing device into at least one response profile in the set of response profiles defined by the response specification based on one or more changes in relation to the measurements relevant to disease activity associated with the medical condition for the subject obtained after or during the treatment.

2. The method of claim 1 wherein the set of response profiles defined by the response specification include one or more of a flat/above response profile, a fast non-sustained full response profile, a fast non-sustained partial response profile, a fast sustained full response profile, a fast sustained partial response profile, a slow non-sustained full response profile, a slow non-sustained partial response profile, a slow sustained full response profile, or a slow non-sustained partial response profile.

3. The method of claim 1 further comprising:
generating information with the information processing device specifying a response phenotype for a response profile.

4. The method of claim 1 further comprising:
identifying a first diagnostic marker associated with the medical condition in a first response profile;
identifying a second diagnostic marker associated with the medical condition in a second response profile; and
determining a difference between the first diagnostic marker associated with the medical condition in the first response profile and the second diagnostic marker associated with the medical condition in the second response profile.

5. The method of claim 1 further comprising:
determining a pattern of response from the set of response profiles that is characteristic of a drug associated with the treatment of the medical condition.

6. The method of claim 5 further comprising:
determining a difference between the pattern of response that is characteristic of the drug and a second pattern of response that is characteristic of another drug.

7. The method of claim 1 further comprising:
associating a response profile in the set of response profiles with a clinical outcome for the medical condition.

8. The method of claim 1 wherein the medical condition comprises rheumatoid arthritis and the treatment comprises at least Rituximab.

9. A non-transitory computer-readable medium storing computer-executable code for detecting how subjects in a population respond to a treatment, the computer-readable medium comprising:
code for receiving data for a population having a medical condition, the data including:
measurements relevant to disease activity associated with the medical condition for each subject in the population obtained before a treatment, and
measurements relevant to disease activity associated with the medical condition for each subject in the population obtained after or during the treatment;
code for receiving a response specification defining:
a set of response profiles, and
information specifying how one or more relationships between measurements relevant to disease activity associated with the medical condition for a subject obtained before a treatment and measurements relevant to disease activity associated with the medical condition for the subject obtained after or during the treatment are used to classify the subject into at least one response profile in the set of response profiles;
code for analyzing the data for the population using the response specification to determine how the measurements relevant to disease activity associated with the medical condition for each subject in the population obtained before the treatment change in relation to the measurements relevant to disease activity associated with the medical condition for the subject obtained after or during the treatment; and
code for classifying each subject in the population into at least one response profile in the set of response profiles defined by the response specification based on one or more changes in relation to the measurements relevant to disease activity associated with the medical condition for the subject obtained after or during the treatment.

10. The computer-readable medium of claim 9 wherein the set of response profiles defined by the response specification include one or more of a flat/above response profile, a fast non-sustained full response profile, a fast non-sustained partial response profile, a fast sustained full response profile, a fast sustained partial response profile, a slow non-sustained full response profile, a slow non-sustained partial response profile, a slow sustained full response profile, or a slow non-sustained partial response profile.

11. The computer-readable medium of claim 9 further comprising:
code for generating information specifying a response phenotype for a response profile.

12. The computer-readable medium of claim 9 further comprising:
code for identifying a first diagnostic marker of rheumatoid arthritis in a first response profile;
code for identifying a second diagnostic marker of rheumatoid arthritis in a second response profile; and
code for determining a difference between the first diagnostic marker of rheumatoid arthritis in the first response profile and the second diagnostic marker of rheumatoid arthritis in the second response profile.

13. The computer-readable storage medium of claim 9 further comprising:
code for determining a pattern of response from the set of response profiles that is characteristic of a drug associated with the treatment of rheumatoid arthritis.

14. The computer-readable storage medium of claim 13 further comprising:
code for determining a difference between the pattern of response that is characteristic of the drug and a second pattern of response that is characteristic of another drug.

15. The computer-readable storage medium of claim 9 further comprising:
code for associating a response profile in the set of response profiles with a clinical outcome.

16. An information processing device for detecting how subjects in a population respond to a treatment, the information processing device comprising:
a processor; and
a memory coupled to the processor and configured to store processor-executable instructions that configure the processor to:
receive data for a population having a medical condition, the data including:
measurements relevant to disease activity associated with the medical condition for each subject in the population obtained before a treatment, and
measurements relevant to disease activity associated with the medical condition for each subject in the population obtained after or during the treatment;
receive a response specification defining:
a set of response profiles, and
information specifying how one or more relationships between measurements relevant to disease activity associated with the medical condition for a subject obtained before a treatment and measurements relevant to disease activity associated with the medical condition for the subject obtained after or during the treatment are used to classify the subject into at least one response profile in the set of response profiles;
analyze the data for the population using the response specification to determine how the measurements relevant to disease activity associated with the medical condition for each subject in the population obtained before the treatment change in relation to the measurements relevant to disease activity associated with the medical condition for the subject obtained after or during the treatment; and
classify each subject in the population into at least one response profile in the set of response profiles defined by the response specification based on one or more changes in relation to the measurements relevant to disease activity associated with the medical condition for the subject obtained after or during the treatment.

17. The information processing device of claim 16 wherein the set of response profiles defined by the response specification include one or more of a flat/above response profile, a fast non-sustained full response profile, a fast non-sustained partial response profile, a fast sustained full response profile, a fast sustained partial response profile, a slow non-sustained full response profile, a slow non-sustained partial response profile, a slow sustained full response profile, or a slow non-sustained partial response profile.

18. The information processing device of claim 16 wherein the processor is further configured to generate information specifying a response phenotype for a response profile.

19. The information processing device of claim 16 wherein the processor is further configured to:
identify a first diagnostic marker associated with the medical condition in a first response profile;
identify a second diagnostic marker associated with the medical condition in a second response profile; and
determine a difference between the first diagnostic marker associated with the medical condition in the first response profile and the second diagnostic marker associated with the medical condition in the second response profile.

20. The information processing device of claim 16 wherein the processor is further configured to determine a pattern of response from the set of response profiles that is characteristic of a drug associated with the treatment of the medical condition.

21. The information processing device of claim 20 wherein the processor is further configured to determine a difference between the pattern of response that is character of the drug and another pattern of response that is characteristic of another drug.

22. The information processing device of claim 16 wherein the processor is further configured to associate a response profile in the set of response profiles with a clinical outcome for the medical condition.
